(19) United States
(12) Patent Application Publication
(10) Pub. No.: US 2009/0164917 A1
(43) Pub. Date: Jun. 25, 2009

(54) SYSTEM AND METHOD FOR REMOTE DELIVERY OF HEALTHCARE AND TREATMENT SERVICES

(76) Inventor: Kevin M. Kelly, Marietta, GA (US)

Correspondence Address: KAPLAN WARD & PATEL LLC, CUMBERLAND CENTER II, 3100 CUMBERLAND BLVD , SUITE 1400, ATLANTA, GA, 30339, US

(21) Appl. No.: 11/960,291

(22) Filed: Dec. 19, 2007

(51) Int. Cl. G06F 3/048

(52) U.S. Cl. 715/757

(57) ABSTRACT

Systems and methods for remote delivery of healthcare and treatment services including a virtual environment in which healthcare providers and patients may interact, wherein costs and inconvenience associated with in-person treatment may be reduced or avoided.

### TECHNICAL FIELD

The present invention relates generally to healthcare treatment, and, more specifically, to systems and methods for remote delivery of healthcare services and treatment, particularly for behavioral and/or psychological illness.

### BACKGROUND OF THE INVENTION

In its current implementation, the healthcare industry is characterized by local, in-person interactions with healthcare providers. Obviously, where physical injury or trauma is involved, such in-person treatment by a qualified healthcare provider is beneficial for the proper and timely delivery of appropriate care. Where physical intervention is not needed, however, and especially for psychological therapy or treatment of mental disease and/or distress, such in-person interactions may not be required. Furthermore, in-person interactions are not even, necessarily, beneficial for delivery of appropriate treatment, and may exacerbate the patient's condition, or may constitute an obstacle to obtaining treatment, as explained in more detail below.

Additionally, the prevailing in-person treatment model is inherently expensive, requiring physical premises such as a hospital or doctor's office, support staff such as receptionists, and the like. Not only is in-person treatment expensive, it also involves other disadvantages, mentioned briefly above. As a more specific example, treatment is typically available at doctor's offices only during business hours, in which case a patient may be unable to make an appointment, or may be inconvenienced by the time and trouble associated with a visit. Furthermore, such in-person treatment cannot be offered in complete privacy. For example, individuals suffering from paranoia or certain phobias, or individuals who may simply be embarrassed by their illness or the surrounding circumstances, may not be comfortable going out in public, or being seen visiting the doctor's office. In these cases, among many others, the inconvenience or reluctance experienced by the patient, such as due to existing social stigma, may actually prevent the patient from obtaining treatment.

In many instances, especially for psychological treatment, but also for many other consultations, therapy or treatment is delivered in the form of counseling, or involves discussion, wherein audio, video, or even text, communication may be sufficient to treat or inform a patient. In circumstances similar to those described above, remote and/or anonymous treatment may indeed be beneficial, by removing obstacles for obtaining treatment. Conventional healthcare delivery systems and methodology, centered around in-person care, do not provide adequate options for such circumstances.

Thus, it is clear that there is an unmet need for a system and method for nationwide or even global delivery of healthcare and treatment services that is capable of reducing the cost and alleviating the inconvenience of in-person treatment options, that is accessible by anyone, anytime, anywhere, and that is capable of delivering appropriate care for patients where anonymity is desired or required.

### BRIEF SUMMARY OF THE INVENTION

Briefly described, in a preferred embodiment, the present invention overcomes the above-mentioned disadvantages and meets the recognized need for such a system by providing a computer network-based system and method for scheduling and conducting psychotherapy, or other counseling or consultation, sessions, wherein patients may meet with qualified healthcare professionals to obtain treatment or consultation in a virtual environment using text, audio, and/or video communication, and that is accessible by anyone, anytime, anywhere, that is focused on individualized and specialized care, that provides for collaboration of national and international physicians, practitioners and other providers, that compensates providers based on their ability to deliver exceptional clinical outcomes.

According to its major aspects, and broadly stated, the present invention comprises a system including a computer network and a computer program product operable to enable text, audio, and/or video communication between at least one patient terminal and at least one provider terminal, and a method of using the system to deliver treatment to the patient. More specifically, the system is preferably formed as a presently-available computer network, such as the Internet, and preferably includes at least one patient terminal in the form of a personal computer located at a first location, and at least one provider terminal in the form of a personal computer located at a second location. The system preferably provides an environment in which one or more avatar(s), or the like, may be controlled by one or more respective associated user(s) of the system. The avatars may be moved about the environment, and may interact with other users through respective avatars in environments designed to recreate real or imaginary spaces or locations, such as a provider's office, a patient's home, a space where symptoms are experienced, or any other desired space.

The system preferably allows a patient to locate, such as through research, contact, and/or arrange to meet one or more providers) and/or other patients for remote communication relating to an illness and/or treatment/diagnosis thereof. The users of the system may preferably define whether such meetings are in the form of private sessions, group sessions, anonymous sessions, formal sessions, informal sessions, paid sessions, free sessions, or the like, and may create, modify, select, and/or visit one or more environment(s) of the system via control of a user-associated avatar to accomplish such meetings and to interact with other participants thereof.

Accordingly, one feature and advantage of the present invention is its ability to allow remote communication between one or more patients and/or healthcare providers, thereby reducing the cost associated with such communication, and thereby increasing the convenience, availability, and/or accessibility of communication with other users of the system.

Another feature and advantage of the present invention is its ability to define and control the characteristics of communications conducted via the system, including ensuring patient privacy and/or anonymity.

These and other features and advantages of the present invention will become more apparent to those ordinarily skilled in the art after reading the following Detailed Description of the Invention and Claims in light of the accompanying drawing Figures.

### BRIEF DESCRIPTION OF THE DRAWINGS

Accordingly, the present invention will be understood best through consideration of, and with reference to, the following drawings, viewed in conjunction with the Detailed Description of the Invention referring thereto, in which like reference numbers throughout the various drawings designate like structure, and in which:

FIG. 1 is a diagram of a system according to the present invention;

FIG. 2 is an illustration of an interface generated by the system as displayed to a user; and

FIG. 3 is an illustration of another interface generated by the system as displayed to a user.

It is to be noted that the drawings presented are intended solely for the purpose of illustration and that they are, therefore, neither desired nor intended to limit the invention to any or all of the exact details of construction shown, except insofar as they may be deemed essential to the claimed invention.

### DETAILED DESCRIPTION OF THE INVENTION

In describing preferred embodiments of the present invention illustrated in the drawings, specific terminology is employed for the sake of clarity. The invention, however, is not intended to be limited to the specific terminology so selected, and it is to be understood that each specific element includes all technical equivalents that operate in a similar manner to accomplish a similar purpose.

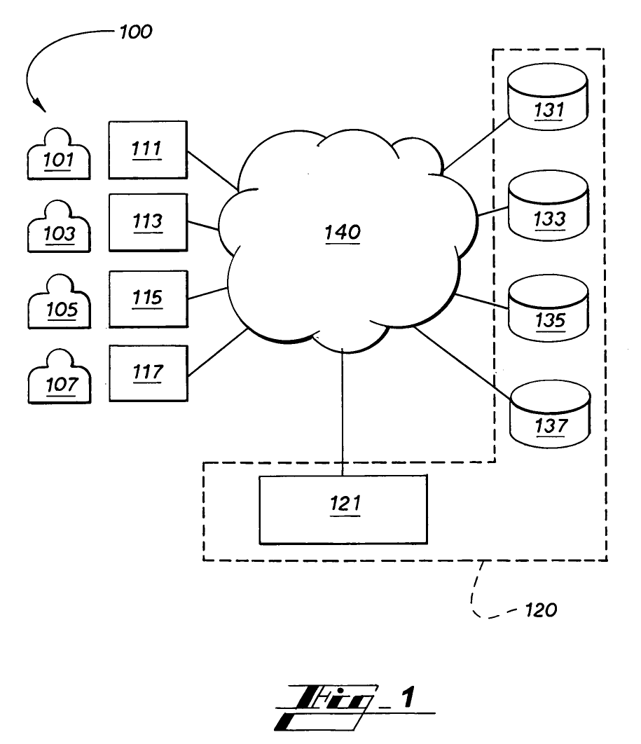

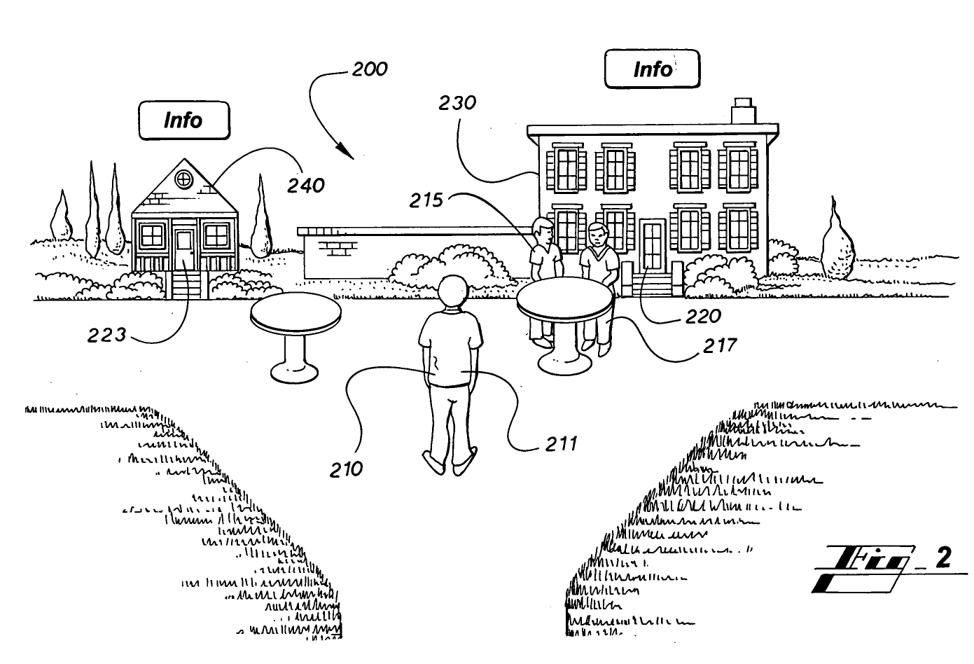

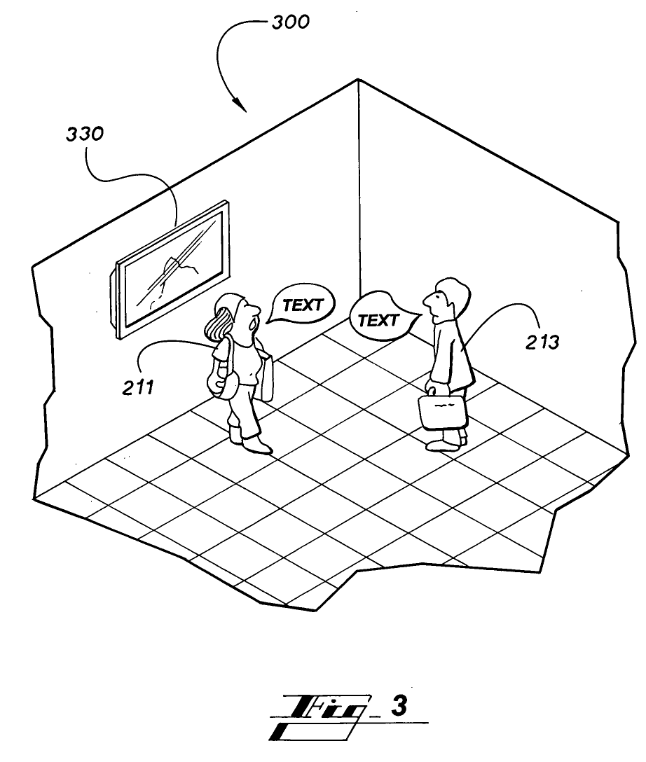

In that form of the preferred embodiment of the present invention chosen for purposes of illustration, FIGS. 1-3 show system 100 including users 101, 103, 105, and 107, respective associated user terminals 111, 113, 115, and 117, host terminal 121, payment database 131, patient database 133, provider database 135, and environment database 137, connected via network 140. As will be understood by those ordinarily skilled in the art, each of user terminals 111, 113, 115, and 117, and host 121 may be formed as a personal computer, a server computer, a dedicated terminal, a portable device, or the like, capable of communicating with the other user terminals 111, 113, 115, 117 and/or host terminal 121 over network 140. In order to provide a greater flexibility of use, network 140 is preferably formed as a wide area network, such as the Internet, and may include wired network components, such as copper wires, optical fibers, or the like, and/or wireless network components, such as radio components, infrared components, or the like. Similarly, each of payment database 131, patient database 133, provider database 135, and environment database 137 may be stored on a storage medium of one or more dedicated server computer(s), that comprise(s) host system 120, or on a storage medium of any other suitable computer or device. For example, environment database 137 may comprise, at least in part, one or more of user terminals 111, 113, 115, or 117, particularly where custom environments specifically associated with a user are used by system 100.

Each user 101, 103, 105, and 107 is preferably exclusively associated with a respective terminal, at least at any given time of use of system 100, such that the identity of the associated user may be verified, at least by host 120, such that, if necessary, emergency personnel or other individuals may be dispatched to assist a selected patient, such as upon indication by a provider that the patient is in crisis, or upon receipt of a signal corresponding to a physiological parameter of the user. Such verification may be accomplished without any of the users of system 100 having access to the actual identity of a given user, such that anonymity, especially for patients, may be afforded, if desired. Similarly, the verification may be used to ensure that a user of the system is, in fact, the user associated with the user terminal or account, whereby system 100 may be able to ensure that the licensed healthcare provider associated with a particular terminal or account is, in fact, the person actually using the system in any situation. Such verification may be accomplished by periodic and/or random transmittal of information from the corresponding user terminal to host 120, such as a biometric input (fingerprint scan, retinal scan, or the like. Such transmittal may preferably be made in response to a request from host 120.

While the identity of at least some of the user's may be kept confidential, as described above, other information, such as information acquired as part of an account and/or avatar creation process, information acquired through use of system 100, including through peripheral devices, or the like, may be accessible by other users. Particularly, medical information of a patient user may be available to an associated provider user, at least during interactions therebetween, and optionally at all times. Thus, system 100 preferably maintains various pieces of information regarding each user, and may selectively prevent or allow access according to predefined, or user-defined, access criteria. Preferably, system 100 maintains a “three-dimensional”patient record, represented at least in part by an avatar, including medical records and/or history, lab and/or test results, genetic information, including sequencing information, genotypes, phenotypes, nutrigenomic information, three-dimensional body scan information, such as CAT scan information, PET scan information, MRI scan information, or the like, insurance information, credit history, payment information, and the like, wherein the three-dimensional record may be patient-controlled and may be portable across real-life and virtual treatment environments and healthcare providers.

System 100 may also include additional peripheral devices to enable selected functionality, such as keyboards, microphones, cameras, speakers, video displays, or the like, in association with one or more of user terminals 111, 113, 115, and 117 for allowing each of users 101, 103, 105, and 107 to interact with, and communicate via, system 100. Additionally, system 100 may include other peripheral devices to enable specific functionality of system 100, such as a payment device for collecting a fee associated with use of system 100, a breath analysis device to verify that a patient under treatment for alcohol addiction has not been using alcohol, a heart-rate monitor, or the like. An output signal of such peripheral device(s) may be monitored and/or recorded by one or both of a provider user and host 120. Accordingly, such peripheral devices may be used to facilitate diagnosis and/or treatment, and/or to create and maintain user information. Many similar devices will be readily apparent to those ordinarily skilled in the relevant art(s), and all such peripherals and other system components are intended to fall within the scope of the present invention, including as may be deemed beneficial or necessary to accomplish the functions described herein, or the like. Accordingly, as advances in hardware and communication technology are made, new devices and techniques may be integrated with or into the system and method of the present invention.

Regardless of the specific configuration of the components of any selected embodiment, system 100 preferably enables communication between at least two users in a virtual environment, wherein each user may interact via text, audio, and/or graphic display, including video display. System 100 is preferably configured to verify user information, such as a username and password when a user accesses system 100, such as via comparison of user-entered information to corresponding information stored in system 100, such as in one or more of payment database 131, patient database 133, and/or provider database 135, or the like. System 100 may preferably provide information to an associated user terminal to cause a selected environment, such as environment 200, to be displayed at a user terminal, whereby the user may interact with system 100, and other users thereof, via control of avatar 210, or the like, associated with the user. Environment 200 provided by system 100 may be a community environment, wherein access to the environment is permitted to all users (at least to all users having the same diagnosis, disease, illness, symptom, or the like). Alternatively, system 100 may provide environment 300 comprising a private environment, wherein only selected users may be provided access, such as when a patient and provider meet for a private session. Advantageously, one or more environments accessible by a selected user may comprise a virtual recreation of a corresponding real space, such as a space with which the selected user is familiar. It will be well understood, however, that some environments of system 100 may be virtual recreations of imaginary spaces, which may be used, for example, to observe a user's behavior in, or physiological response to, a selected environment and/or stimulus therein.

Users may interact with system 100, and with other users thereof, each other user preferably represented by an associated avatar 210, via directing movement of their associated avatar 210 through the environment, and via manipulation of one or more element(s) 220 therein. Direction of avatar 210 and/or activation of element 220 may be accomplished, for example, by keystrokes, voice commands, mouse inputs, or the like, and may be regulated by governance rules or criteria of system 100, such as by selectively granting access to one or more environment(s) and/or element(s) and/or by governing allowable behaviors by users. For example, a given user may access a selected one of various different environments, such as environment 300, by directing the user's associated avatar to a location where access to the environment may be gained, such as a graphic representation of a building 230 housing the selected environment. The user may arrange, either via system 100 or via another associated or independent system, to meet a selected user in the selected environment to conduct any of the activities described below, or similar activities, to achieve the healthcare treatment functions of system 100. Optionally, the user may be automatically placed into a selected treatment environment associated with one or more healthcare providers by system 100, such as part of an orientation, based on the user's insurance and payment information, based on provider availability, or the like.

For example, one selected environment may comprise a living room, such as a virtual recreation of the real living room of the user. Thus, the user's familiarity with, and associated feelings of comfort and security in, the environment may beneficially improve or enhance the effectiveness of certain mental healthcare services delivered through system 100, including by encouraging the sharing of sensitive personal information. Furthermore, when the selected environment comprises such a recreation of a real environment, one or more healthcare provider(s), such as user 103, for example, may be able to observe and/or interact with one or more patient, such as user 101, for example, in a situation in which user 101 experiences symptoms of an illness, such as desires to use a substance to which user 101 is or has been addicted, or where any other event(s) may take place, or have taken place, that are relevant to the patient's disease(s), illness(es), or symptom(s). Additionally, friends and/or family of the patient(s), or other individuals deemed necessary or beneficial to provide treatment, may also be included in the interaction, regardless of physical location. As mentioned briefly above, however, virtual recreations of imaginary environments may likewise be beneficial, such as where user 103 may observe or interact with user 100 in a new or hypothetical situation, such as to determine what reaction user 101 may have and/or to deliver treatment and/or counseling while user 101 is experiencing the new or hypothetical environment. As will be understood by those ordinarily skilled in the art, such observation and/or delivery of treatment/counseling is not reliably reproducible in a conventional hospital or doctor's office setting. For example, during a single session users 101 and 103 may interact in a plurality of different environment on demand, wherein each of the environments may be adapted to facilitate a different aspect of treatment, and/or may be adapted specifically for treatment of user 101, or a specific group of patients.

System 100, thus, not only allows convenient interaction between a patient, such as user 101 and a healthcare provider, such as user 103, in reproducible environments that are not available, convenient, or reliable in conventional treatment venues, but also allows convenient interaction between the patient and the healthcare provider regardless of the time and/or the relative physical locations of users 101 and 103. Thus, system 100 preferably provides for specialized and/or personalized treatment, and a level of convenience and cost-effectiveness not achievable or practical in real-world treatment settings. For example, if a patient is experiencing symptoms, or encounters any kind of emergency or other urgent need for care, system 100 may provide access for user 101 to needed treatment services at any time of day, and further offers the option to receive such treatment in an environment that is familiar to user 101, and in which user 101 is comfortable. Similarly, system 100 preferably allows patient user 101 to maintain a pre-existing treatment or counseling relationship with provider user 103 even though user's 101 and 103 are no longer within geographic proximity to enable in-person meetings, such as where user 101 is on a trip, relocated to a new geographic region, temporarily or permanently, or the like. Furthermore, not only is continuity of the treatment relationship maintained in such circumstances by system 100, but users 101 and 103 may further benefit from continuity of treatment environment if a pre-existing relationship existed within system 100, or if system 100 provides a virtual environment substantially similar to a real space in which treatment or counseling occurred.

System 101 preferably further facilitates such delivery of treatment, whether on an urgent basis or not, by integrating many, if not all, of the functions of a healthcare system. For example, system 101 preferably includes a billing feature, wherein a predefined quantity of currency, whether conventional or electronic, is transferred from one or more patient user(s) to one or more provider user(s) during selected interactions. For example, a user's credit card, bank account, or the like may be associated with system 100 to automatically deduct payments in conventional currency. Alternatively, system 100 may operate on its own unique currency, such as “identity dollars” or other electronic credits, including physical counterparts such as tokens or coupons, with such unique currency being obtained in exchange for conventional payments, whereby a user may purchase treatment and/or support in blocks of time, treatments sessions, or the like. Thus, a provider may automatically receive payment for a predetermined fee associated with any selected interaction conducted via system 100, such as an hourly fee, a flat fee, or the like. In addition to verifying payment and transferring currency, system 100 may include a benefit verification feature, wherein a patient user may determine, through system 100, either automatically or upon request, whether, and to what extent, services offered by a selected provider user may be covered by the user's insurance, or the like. System 100 may further include a financing feature, wherein payment for any services, or portions thereof, not covered by insurance benefits may be arranged. Thus, system 100 preferably integrates, simplifies, and/or automates many, if not all, functions necessary for the provision of healthcare services therethrough. Accordingly, users may be relieved of the burdensome need to ensure satisfactory completion of these functions, and may, instead, focus on treatment of the patient(s).

For example, as user 101 navigates community environment 200, a plurality of virtual provider facilities 240 may be displayed. Each such virtual provider facility may preferably include information to assist user 101 in deciding whether he or she wants to obtain services from an associated provider, such as user 103. In one embodiment, relevant information may automatically be displayed to user 101, such as in the form of a sign on the virtual facility, which conveys to user 101 such as whether the insurance provider of user 101 will cover some or all, and how much, of the charges of user 103. Preferably, system 100 automatically customizes such information displayed to each user according to information associated with such user stored in one or more of payment database 131, patient database 133, and provider database 135. Additionally or alternatively, user 101 may select, such as during an account creation or account management process of system 100, criteria for display of providers, virtual provider facilities, and/or provider information. For example, user 101 may select criteria for display of provider information that only permits providers and/or virtual provider facilities to be displayed if they meet the selected criteria, such as whether a selected percentage of the provider's charges will be covered by the user's insurance.

Beyond making improvements to conventional systems and methodologies, system 100 preferably enables unique features, such as an experiential and/or objective user rating system, wherein users, such as healthcare providers, may receive a rating according to a set of criteria, such as a “flourishing index” or “quality of life index”, generated by system 100 in response to various selected inputs from users, and other selected factors, for use in assisting all users in determining which user's are achieving desired results, such as defined clinical results or outcomes, and to what extent. By way of example only, system 100 may initiate a questionnaire or survey when a selected user accesses system 100. System 100 may generate a score based on responses to the survey, and save the score for later comparison. The user's activities, such as the identity of each healthcare provider (or any other user or feature of system 100) may be flagged during use of the system. System 100 may initiate another similar or different questionnaire or survey at a later time, such as after an interaction with a provider, or after logging off system 100, and a second score may be generated based on the responses to the second questionnaire for comparison to the first score. The change in the user's score may be associated with one or more of the features and/or users with which the user interacted, and may be used, at least in part, to generate a rating for the associated user and/or service of system 100. The rating system may preferably include a plurality of inputs or factors for generating a rating, especially for providers, such that user's of system 100 may access such rating to determine an effectiveness of an associated user or feature. In one embodiment, a provider user's rating is immediately displayed to other users who encounter the provider user within system 100. As with other criteria, a user may block providers who have a rating below a predetermined minimum threshold.

According to a simple implementation of the flourishing index feature of system 100, an indication of a patient user's status may be indicated by a color associated with the user's current status. For example, a green color may be associated with those user's whose scores, and therefore quality of life, are increasing, while yellow may be associated with those user's whose score remain generally unchanged, and red may be associated with those user's whose scores are decreasing, i.e. whose symptoms are worsening. The color may be associated with a display of the user's name, with the user's avatar, with a piece of clothing of the user's avatar, or may be hidden from view within the environments of system 100 and may instead only be accessible via a report sent to an associated user, such as the user's healthcare provider. Additionally, a change in the user's status, whether in an implementation using the three states described above, or in another more or less complicated implementation, may automatically generate a notification to the user's healthcare provider.

As with patient users, described above, the flourishing index feature of system 100 may likewise be used with provider users of system 100. For example, a billboard, sign, or other element associated with the provider user's virtual facility, and/or a name or other element associated with the provider user's avatar may correspond to the score attributed to the provider user based on use of system 100. Thus, when patients of the provider user achieve increases in assessment scores, the provider user may likewise receive higher scores, whereby patient users may learn which provider users of system 100 are effective in improving the quality of life of their patients. Alternatively, however, such provider score may not be indicated throughout the environments of system 100, and may instead be used by insurance companies, or the like, in evaluating healthcare providers.

In use, a patient, such as user 101, may obtain healthcare services by accessing host 120 via network 140, such as through a website, through a dedicated client software product installed on user terminal 111, or the like. In the case where a dedicated client software product is used to access host 120, such software product may have previously been installed on the patient's personal computer, such as user terminal 111, via download from host 120, or via a physical medium, such as an installation disk. When user 101 first accesses host 120, host terminal 121 preferably elicits login information from user 101, such as a username and password. The login information may be entered by user 101 via a login screen, or another interface, provided to user 101 by the software product, or the like. Host terminal 121 preferably verifies that the login information provided matches login information stored in one or more of payment database 131, patient database 133, and provider database 135.

If user 101 has not previously used system 100 or does not have an account, user 101 is preferably guided through an account creation process, wherein the user's personal information, payment information, insurance information, and the like may be stored in one or more of payment database 131, patient database 133, and provider database 135. Where desirable, host 120 may elicit biometric information from user 101 for use in verifying provided login information. For example, a user's fingerprint scan, retinal scan, or the like, may comprise at least a portion of the user's login information, and such biometric information may be required for verification each time the user accesses host 120, and/or randomly or periodically during use of system 100.

The account creation process preferably further includes an avatar creation process, in which user 101 may select an avatar 211 with which the user will be associated for use of system 100. Preferably, avatar 211 created during the account creation process is selected to accurately recreate the physical appearance of user 101, such that user 101, as well as other users of system 100, may recognize each unique avatar of system 100 as being associated with a respective unique user, at least where such identification is desired. In one embodiment, the account creation process, or at least the avatar creation process, includes a full three-dimensional body scan of user 101 for automatic generation of avatar 211 associated therewith, comprising a virtual recreation of the physical appearance of user 101. Such scan and avatar creation may be accomplished at the user's home, office, doctor's office, or any other convenient location. Specifically, a full body CAT scan, MRI scan, PET scan, or the like may be used to capture three-dimensional information of the user's body, including the user's face, for use in creating an accurate virtual recreation of the user comprising the user's avatar. Furthermore, in an effort to develop a complete profile of each user, especially patient users, the account or avatar creation process may include acquisition of various additional information, such as a user's genetic sequence, medical records, history, or the like.

The account creation process may, optionally, further include a three-dimensional scan of one or more real environments, including objects found therein, associated with user 101, such as the user's home environment, work environment, recreation environment, or the like. Such three-dimensional scans of real environments may preferably be used for generation of associated virtual environments that may be stored on environment database 135 for use in system 100. Access information for each such virtual environment may additionally be provided, such as by user 101 or by host 120 to selectively permit or deny access to such virtual environments upon an access request from a user of system 100. As an example, users may invite other users to participate in peer support meetings conducted in environments comprising virtual recreations of real-life private spaces, such as a user's home.

Finally, the account creation process may further include a diagnosis process. Such diagnosis process may include an in-person visit with a healthcare provider associated with system 100 including users of system 100, a private communication between user 101 and a healthcare provider using system 100, a questionnaire, laboratory tests, and/or output signals of one or more biometric feedback peripheral device, or the like. According to the results of the diagnosis process, system 100 may associate user 101 with one or more unique community environments, with each community environment being dedicated to basic research, translational research, clinical practice, treatment, and/or support associated with a corresponding specific disease, illness, symptom, or combination thereof, designed for user's suffering therefrom.

If the provided information matches the stored information associated with user 101, access to host 120 is permitted to user 101 via user terminal 111. As a preliminary matter, system 100 may preferably elicit responses from user 101 relating to the user's subjective and/or objective current or recent experiences of symptoms, mood, happiness, or the like, in order to establish a baseline or pre-interaction quality of life score. System 100 may then preferably allow user 101 to use system 100 via display of community environment 200, such as a recreation of an imaginary island, to user 101 via user terminal 111.

As a further preliminary matter, system 100 may provide an orientation, particularly for new users, such as first-time users, or users having accessed the system fewer than a predetermined number of times, or for less than a predetermined amount of time. The orientation preferably instructs user 101 regarding the features and functionality of system 200 including providing helpful hints and answering frequently asked questions. Thus, the orientation preferably facilitates competent use of system 100, including all desired features, elements, and environments thereof.

User 101 may preferably move avatar 211 through environment 200 to access a selected element associated with another desired environment of system 100, or may simply interact with other users within environment 200. Control of avatar 211 may be accomplished according to any convenient technique, including keystroke, mouse input, joystick, voice commands, or the like. User 101 may communicate with other patient users 105 and 107 in community environment 200, such as a within a space resembling a common room, or an outdoor space, preferably via respective associated avatars 215 and 217. Thus, system 100 preferably provides a communication forum analogous to support group interaction. Unlike support group meetings, however, user 101 may access system 100 anytime, and from anywhere, and, upon accessing community environment 200, may find other user's who suffer from, or specialize in treating, the user's disease(s) illness(es), and/or symptom(s). Furthermore, system 100 may enable notifications to user 101, such as through automatic voicemail, email, text message, or the like, such as when one or more selected user(s), such as the user's healthcare provider(s) or the user's friends or family, log in to system 100. Thus, user 101 may log on to system 100 in response to such a notification to communicate with a selected user, either in a community or a private environment.

Another use of such a notification system may take the form of a text message, email, voicemail, or the like sent to a healthcare provider, such as user 103, upon the occurrence of a selected event. The triggering event may be any selected event, such as use of a selected word or phrase by a patient user associated with user 103, receipt of a signal generated by a peripheral device associated with a patient user indicating that the patient user has used a substance to which the patient user is, or has been, addicted, an emergency signal generated by a patient user, or the like. Furthermore, system 100 may be operable with other systems, such as police systems, emergency medical systems, hospital systems, of the like, to transmit and/or receive signals or information to enhance the features available to users of system 100. For example, system 100 may automatically be notified of, or scan and retrieve information pertaining to, an arrest of a user, a medical emergency of a user, a hospitalization of a user, or the like. Such information may be stored with an associated user's information and/or may be used to generate a notification of such event or information to a healthcare provider for use in diagnosis, treatment, and/or intervention.

Communication between users 101, 105, and 107 may, likewise, take any convenient form, such as text chat, private messaging, voice chat, avatar gestures, video chat, or the like. Preferably, a user's communication(s) are associated with the user, such as appearing in the proximity of the user's avatar, or the like. Such communications may be public or broadcast, being accessible to all users present in environment 200, within a proximity range of the communicating user, or the like, or may be private in nature, wherein access is restricted to one or more selected users. Such private communication may be accomplished via instant messaging, private voice chat, private video chat, or the like.

Additionally, communication between users 101, 105, and 107 may be anonymous in nature such that none of the users has access to the identity of the others. Such anonymity may be particularly beneficial in fostering complete disclosure of personal information, whereby a better understanding of the nature of the patient's disease(s), illness(es), and/or symptom(s) may be achieved, and whereby more effective treatment may be provided. Such anonymity may be controlled by the user, and selectively applied to one or more of the other users of system 100. For example, each user may define a group of other users to whom their identity may be accessible or revealed during use of system 100, including, for example, the user's name, appearance, location, or the like. Furthermore, such anonymity may be applied according to specific rules or criteria according to environment. Thus, user 101 may select, for example, to maintain anonymity, including displaying an anonymous avatar, to all users in all community environments, but may allow all users to have access to the user's identity information, including their appearance while in private environments, such as a private treatment environment, a restricted group treatment environment, or the like.

As will be understood by those ordinarily skilled in the art, system 100 may retain a user's personal information, including all information acquired or provided during an account and/or avatar creation process, as well as any and all information acquired by system 100 during the user's participation in or use of system 100, while still maintaining each user's privacy and anonymity as desired and/or required. Thus, even if other users are not able to access a particular user's personal information, system 100 may nevertheless reveal such information, if and when necessary to enable emergency intervention, such as in a crisis situation, such as may be determined by biometric information provided by the user, or as may be determined by providers in their professional judgment.

Users 105 and 107 are preferably patient users who suffer from the same disease(s), illness(es), and/or symptoms(s), or combinations thereof, as does user 101. Thus, environment 200 may be specifically provided to allow patient users with similar treatment needs and experiences to interact without distractions, diversions, or confusion introduced by the presence of users with different treatment needs and experiences, associated with different diseases, illnesses, or symptoms. System 100 may optionally include as many analogous environments as desired for use by analogous groups of patients suffering from one or more different disease(s), illness(es), and/or symptom(s), or combinations thereof.

Similarly, system 100 may thus facilitate specialization by healthcare providers, such as user 103, by offering access to a large number of similarly-situated patients, regardless of geographic location, wherein provider 103 may specialize in treating a desired disease, illness, and/or symptom, or combination thereof, regardless of how specific such specialty may be. Furthermore, by limiting interactions to only those with patient users appropriate for the desired specialty, at least where the provider desires such limited interaction, the provider may be able to gain additional insights into appropriate and/or productive treatment methodologies that may be clouded or obscured by application of the treatment methodologies to a more diverse patient pool.

For example, in testing a treatment method, a provider may erroneously associate poor results experienced by some patients with ineffectiveness of the method simply because the patients experiencing such poor results may have additional or different illnesses for which the treatment is not optimal or is counter-productive. Nevertheless, the treatment may be beneficial for a subset of the patients, and such effectiveness may go unrecognized without uniformity of patients. Conventional treatment methodologies, that force grouping of diverse patients into the same treatment group due to cost pressures and geographic restrictions, disadvantageously prevent trial, evaluation, and use of such illness-specific treatments.

When user 101 has finished interacting with users 105 and 107, user 101 may log off system 100, such as via entry of an appropriate command, or via manipulation of an element within environment 200. Before user 101 can complete the log off process, system 100 preferably elicits responses, similar to those for generating the baseline quality of life score, for generating a post-experience quality of life score. A comparison of the two scores may preferably provide information regarding the user's actual and/or perceived benefit of use of system 100 and/or one or more specific elements thereof.

Additionally, or alternatively, to interacting with users 105 and 107 in community environment 200, user 101 may move avatar 211 through community environment 200 to a selected element 220 thereof in order to access an associated private environment 300. Private environment 300 may be, for example, a virtual recreation of a healthcare provider's office, wherein user 101 and a healthcare provider, such as user 103, may interact through avatars 211 and 213 for the delivery of treatment. By resembling the office of user 103 private environment 300 preferably maintains a continuity of environment between in-person visits to the real office and virtual visits to the recreation of the office using system 100. As discussed above, private environment 300 may take the recreation of any real space desired by user 101 and or user 103.

Additionally, private environment 300 (as well as community environment 200) may include element 330 for delivery of pre-recorded content, such as videos, movies, audio recordings, tests, or the like. Preferably, element 330 is displayed as a graphic element within private environment 300, such as in the form of a television, or other appropriate graphic, according to the content accessed thereby. Thus, user 101 may access selected content by activation of element 330, such as by clicking on the graphic element associated therewith, to access the content. For example, as part of a counseling session, user 101 may watch a video via element 330. User 101 may view the video before, during, or after an interaction with user 103, as deemed appropriate. Such pre-recorded content may preferably enable user 103 to provide treatment using system 100 that is the equivalent of treatment that may be given in the real office of user 103.

In an exemplary implementation, user 101 may be a regular patient of user 103, and typically receives treatment in the office of user 103. When user 101 is out of town on business, or when a visit to the office is otherwise not possible or simply inconvenient, user 101 may receive treatment in private environment 300. For example, on the day user 101 is scheduled to visit user 103 at the office of user 103, there may be a traffic jam caused by an accident that would prevent user 101 from arriving for the appointment on time, or would cause user 101 to leave work early. Instead of visiting the office, user 101 may simply use terminal 111, such as a personal computer, or a dedicated public access terminal booth located, for example, in the office building where user 101 works, in a local coffee shop, or the like, to visit with user 103. User 101 may preferably use terminal 111 to log into system 100 by providing access information associated with user 101, such as a username and password. Upon accessing system 100, user 101 may preferably navigate avatar 211 through environment 200 to element 223 in the form of a door of a virtual facility associated with user 103. System 100 preferably allows user 101 to access environment 300 via element 223, wherein user 101 may meet user 103 represented by avatar 213. Users 101 and 103 may then preferably communicate via text, audio, and/or video transmissions via system 100 to deliver treatment. Thus, inconvenience to both user 101 and user 103 may be avoided since user 101 need not cancel or arrive late, and need not leave work early. In fact, user 101 may elect to regularly use system 100 instead of visiting the office of user 103 to save time, save travel expenses, or the like.

In another exemplary implementation, user 101 may be suffering from agoraphobia, social phobia, generalized anxiety disorder, or the like, wherein symptoms include a fear or avoidance of face-to-face social interaction and/or public excursions. User 101 may be diagnosed, via an in-person consultation with a healthcare provider, or via a consultation or evaluation provided using system 100. Preferably an in-person meeting is scheduled, if such meeting has not already taken place, wherein user 101 and a selected healthcare provider, such as user 103, may become acquainted and develop points of reference, including the physical appearance of one another and a physical space. User 101, either alone or with the assistance of user 103, of another individual associated with system 100, or through a tutorial provided by system 100, preferably prepares user terminal 111 for use of system 100 to communicate with other users, including user 103, which may involve installation of software, association of peripheral devices, or the like. A three-dimensional scan is taken of a selected physical space, such as the space in which the initial meeting takes place, or another space with which user 101 is familiar, such as the home of user 101. The three-dimensional scan is then preferably used by system 100 to generate a private environment comprising a recreation of the physical space, and is preferably associated with user 101 and/or user 103. Similarly, a three-dimensional scan of user 101 is taken (and of user 103 is not already taken) and used by system 100 to generate an avatar associated with user 101 comprising a recreation of the physical appearance of user 101. Alternatively an avatar may be created without such scan. Information associated with user 101 is then preferably stored within a storage medium of system 100, including on user terminal 111, and associated with a user account for user 101 and the avatar therefor. The information may include user medical records, test results, provider evaluations or reports, insurance information, bank information, credit card information, payment history, diagnosis information, and the like. Users 101 and 103 may then preferably log on to system 100, whether during an in-person meeting, or remotely, and conduct tours of one or more selected environments), access pre-made content of system 100, engage in conversation with each other and/or with additional or different users, or the like (i.e. in public or private, and in group or one-on-one sessions). System 100 may then preferably automatically bill user 101 for the use of system 100 and/or for services provided by user 103, including automatically submitting such bills to the insurance company of user 101. Furthermore, system 100 preferably automatically obtains payment from user 100 for at least a portion of such bills, such as a co-pay, co-insurance, uncovered amount, deductible, or the like, if appropriate, as determined by information of user 101, and, optionally, automatically disburse at least a portion of such payment to user 103 and/or other healthcare providers. The effectiveness of the experience of user 101 is then preferably evaluated, and recorded. A status or score of each or both of users 101 and 103 may then be adjusted according to the evaluation of effectiveness of the interaction.

In another exemplary implementation, user 101 may be a soldier, or other individual who is assigned to a position or job away from their home. User 101 may go through the account, avatar and private environment creation processes described above, or similar processes adapted to obtain relevant information and to generate an appropriate avatar and one or more environment. In advance of deployment, user 101 may access system 100 to become acquainted with use thereof, as well as the environments thereof. User 101 may further interact with one or more healthcare provider(s) to establish baseline evaluations, to prepare user 101 for anticipated experiences, including typical stressors, or even to prepare user 101 for the experience of deployment through simulations. Furthermore, avatars associated with family members, such as users 105 and 107, may be created, and users 101, 105, and 107 may interact via system 100 prior to deployment of user 101.

After deployment, user 101 may continue to communicate with one or more of users 103, 105, and 107, individually or together. User 103 may preferably monitor the psychological and/or physiological effects of such deployment on users 101, 105, and/or 107, and may recommend and/or provide treatment as appropriate. Such treatment may include communications using system 100 and/or in-person communications. As an added feature, system 100 may notify any or all of users 103, 105, and 107 when user 101 logs on to system 100, or when user 101 enters a selected environment, such as an environment comprising a recreation of the home of user 101.

In another exemplary implementation, user 101 may access system 100, visit a private environment associate with user 103, the doctor of user 101, instead of visiting the physical office of user 103. Users 101 and 103 may interact within the private environment to discuss the results of laboratory tests, or other tests, previously conducted. User 103 may explain the results, and the implications thereof, including giving appropriate advice for treatment, and user 101 may communicate questions, give additional information, or the like. User 103 may additionally provide user 101 with a prescription, a referral, or the like, when necessary.

It is important to note that, at least in some circumstances, the environments and avatars of system 100 should be formed as accurate recreations of real-life counterparts. By achieving such accurate recreations of real places and individuals, system 100 may foster realistic behavior therein by users. Accordingly, the likelihood of user 101 acting “out of character” or developing an alter ego is reduced by the anchor in reality provided by the realism of the environments and avatars of system 100.

Having thus described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is at least:

1. A method for delivery of healthcare services comprising the steps of:
providing a computer system capable of displaying a virtual environment to at least one user, the at least one user being selected from the group consisting of a patient and a healthcare provider;
displaying a first avatar associated with a respective first user of the system within the environment, the first user being a patient; and
communicating with the first user to deliver healthcare services,
wherein said step of communicating with the first user comprises providing at least one of audio information, video information, and text information to the first user, and wherein the at least one of audio information, video information, and text information is associated with at least one of an element of the virtual environment and a second avatar associated with a respective second user of the system.

2. The method of claim 1, wherein the computer system includes information corresponding to the first user and wherein the computer system customizes the virtual environment displayed to the first user based on the information.

3. The method of claim 1, wherein the computer system transfers a payment from the first user to the second user.

4. The method of claim 1, further comprising the steps of generating a rating for the communication and incorporating an indication of the rating within the virtual environment, wherein the indication is associated with the at least one of an element of the virtual environment and the second user.

5. The method of claim 1, wherein the virtual environment is associated with a selected condition, and wherein the virtual environment is displayed only to users associated with the selected condition.

6. The method of claim 1, further comprising the step of accessing a private environment of the system, and wherein the at least one of the element and the second avatar is associated with the private environment.

7. The method of claim 6, wherein the element associated with the private environment comprises a virtual facility, and wherein the private environment comprises a virtual recreation of a physical space selected from the group consisting of an office of a healthcare provider and a home of a patient.

8. The method of claim 1, further comprising the step of collecting data from the first user regarding situations or settings that trigger certain undesired behavior, and wherein the computer system customizes the virtual environment displayed to the first user based on said situations or settings.

9. A system for delivery of healthcare services comprising:
a first user terminal for providing access to said system to a first user, said first user being a patient;
a second user terminal for providing access to said system to a second user, said second user being a healthcare provider; and
a computer program product stored on a computer readable medium capable of causing three-dimensional virtual environment to be provided to each of the first user and the second user,
at least one database for storing information associated with each of the first user and the second user,
wherein at least one of said first user and said second user communicate via an avatar associated with a respective one of the first user and the second user to deliver healthcare services to the first user.

10. The system of claim 9, wherein the virtual environment corresponds to situations or settings that trigger certain undesired behavior of the first user.

11. The system of claim 9, further comprising a database for storing initial data associated with a first user's condition and subsequent data associated with a first user's condition, and a computer program product stored on a computer readable medium capable of comparing said initial data and said subsequent data and creating an improvement index for said first user.

12. The system of claim 11, wherein said improvement index for a plurality of first users is associated with a second user to provide a rating for said second user.

13. A method for determining an index for the effectiveness associated with online healthcare services comprising the steps of:
providing a computer system capable of displaying a virtual environment to at least one patient, said patient having a need for treatment;
collecting at least an initial first set of data associated with the patient's need for treatment;
analyzing the initial first set of data and creating a base score therefrom;
providing treatment to the patient via the virtual environment;
collecting at least a second set of data associated with the patient's need for treatment;
analyzing the at least second set of data and creating at least a second score therefrom; and
comparing the base score with the at least second score to create at least a first index, wherein said index is indicative of the effectiveness of the treatment.

14. The method of claim 13, wherein the steps of collecting at least an initial first set of data and collecting at least a second set of data is performed via a series of questions.

15. The method of claim 13, further comprising the step of associating said index with a treating healthcare provider.

16. The method of claim 15, wherein a plurality of patient indexes are associating with a specific treating healthcare provider to produce and display a rating for said healthcare provider for patients to know the specific treating healthcare provider's effectiveness.

17. The method of claim 16, wherein a patient can select a predetermined minimum rating threshold so as to exclude treating healthcare providers having a rating below said predetermined minimum.
